(19) United States
(12) Patent Application Publication
(10) Pub. No.: US 2013/0308952 A1
(43) Pub. Date: Nov. 21, 2013

(54) Small Form Factor, Pluggable, Analog Optical Transmitter and Host Module

(71) Applicant: Aurora Networks, San Clara, CA (US)

(72) Inventors: Steve Hopkins, Union City, CA (US); Brian Ishaug, Pleasanton, CA (US); Zulfikar Morbi, San Jose, CA (US); Oleh Sniezko, Dillon, CO (US)

(73) Assignee: Aurora Networks, Santa Clara, CA (US)

(21) Appl. No.: 13/672,716

(22) Filed: Nov. 9, 2012

Related U.S. Application Data
(60) Provisional application No. 61/628,933, filed on Nov. 9, 2011.
(60) Provisional application No. 61/628,923, filed on Nov. 9, 2011.
(60) Provisional application No. 61/629,030, filed on Nov. 10, 2011.
(60) Provisional application No. 61/629,029, filed on Nov. 10, 2011.
(60) Provisional application No. 61/629,028, filed on Nov. 10, 2011.

(51) Int. Cl. H04B 10/2575

(52) U.S. Cl. CPC H04B 10/2575
USPC 398/115; 398/182

(57) ABSTRACT

A method includes hosting a plurality of transmitter modules with a host module, where the host module includes common circuitry shared by the plurality of pluggable transmitter modules. An apparatus includes a host module; and a plurality of transmitter modules coupled to the host module, where the host module includes common circuitry shared by the plurality of pluggable transmitter modules.

### CROSS-REFERENCES TO RELATED APPLICATION(S)

This application claims a benefit of priority under 35 U.S.C. 119(e) from copending provisional patent applications U.S. Ser. No. 61/628,933, filed Nov. 9, 2011, U.S. Ser. No. 61/628,923, filed Nov. 9, 2011, U.S. Ser. No. 61/629,030, filed Nov. 10, 2011, U.S. Ser. No. 61/629,029, filed Nov. 10, 2011 and U.S. Ser. No. 61/629,028, filed Nov. 10, 2011, the entire contents of all of which are hereby expressly incorporated herein by reference for all purposes.

### BACKGROUND

Current transmitter technology requires quite a lot of space and density is becoming more of an issue in the market. Power consumption is high in today's transmitters because they have to copy common circuitry from module to module.

### SUMMARY

There is a need for the following embodiments of the present disclosure. Of course, the present disclosure is not limited to these embodiments.

According to an embodiment of the present disclosure, a process comprises: hosting a plurality of transmitter modules with a host module, where the host module includes common circuitry shared by the plurality of pluggable transmitter modules. According to another embodiment of the present disclosure, a machine comprises: a host module; and a plurality of transmitter modules coupled to the host module, where the host module includes common circuitry shared by the plurality of pluggable transmitter modules. These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The drawings accompanying and forming part of this specification are included to depict certain embodiments of the present disclosure. A clearer concept of the embodiments described in this application will be readily apparent by referring to the exemplary, and therefore nonlimiting, embodiments illustrated in the drawings (wherein identical reference numerals (if they occur in more than one view) designate the same elements). The described embodiments may be better understood by reference to one or more of these drawings in combination with the following description presented herein. It should be noted that the features illustrated in the drawings are not necessarily drawn to scale.

FIG. 1 is block schematic view of an analog transmitter module, representing an embodiment of the present disclosure.

FIG. 2 is block schematic view of a host module, representing an embodiment of the present disclosure.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well known signal processing techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

Embodiments of the invention relate to transmission of analog and/or digital signals over fiber optics. More specifically, some embodiments of the invention relate to small form factor pluggable modules for transmission systems such as, but not limited to, CATV systems. The disclosure of this application is marginally related to copending U.S. Ser. No(s). ______ (attorney docket number AUROR1350-1), filed Nov. 9, 2012, ______ (attorney docket number AUROR1360-1), filed Nov. 9, 2012, ______ (attorney docket number AUROR1380-1), filed Nov. 9, 2012, ______ (attorney docket number AUROR1390-1), filed Nov. 9, 2012, the entire contents of all of which are hereby expressly incorporated by reference for all purposes.

Embodiments of the invention enable common circuitry to be shared amongst multiple pluggable transmitter modules which will not only reduce power consumption, but will also improve reliability due to lower component counts. Embodiments of the invention will also allow higher density as multiple transmitter modules can be inserted into the space that a single transmitter once occupied.

Embodiments of the invention can include a small form factor optical transmitter module that is designed to plug into a host module. A practical use of embodiments of the invention is to make low cost, high density, easily replaceable transmitter modules for 1310 nm and 1550 nm analog transmission over fiber optic cables. The host module can have any number of pluggable modules limited only by physical space available in the host module. The pluggable modules can accept a broadband RF input. The input can include, but is not limited to, a mixture of analog (8 VSB modulated) channels in addition to QAM channels intended to transmit linear video, SDV (switched digital video), VOD (video on demand), IPTV (internet protocol television) and/or DOCSIS (data over cable service interface specification) content. The small form factor can be the existing SFP (small form factor pluggable), or XFP (next generation form factor pluggable) or similar form factors, but is not limited to only these standards.

Embodiments of the invention can include a plug-in optical transmitter having a card-edge connector that supports a variety of functions and/or hardware including, but is not limited to, DC power, control, RF input, signal conditioning circuitry including impedance matching, amplifiers, attenuators, pre-distortion circuitry, TEC (thermal electric cooler) and TEC control, SBS (stimulated Brillouin scattering) suppression circuitry, hot swap circuitry, laser plus associated circuitry and a micro-controller.

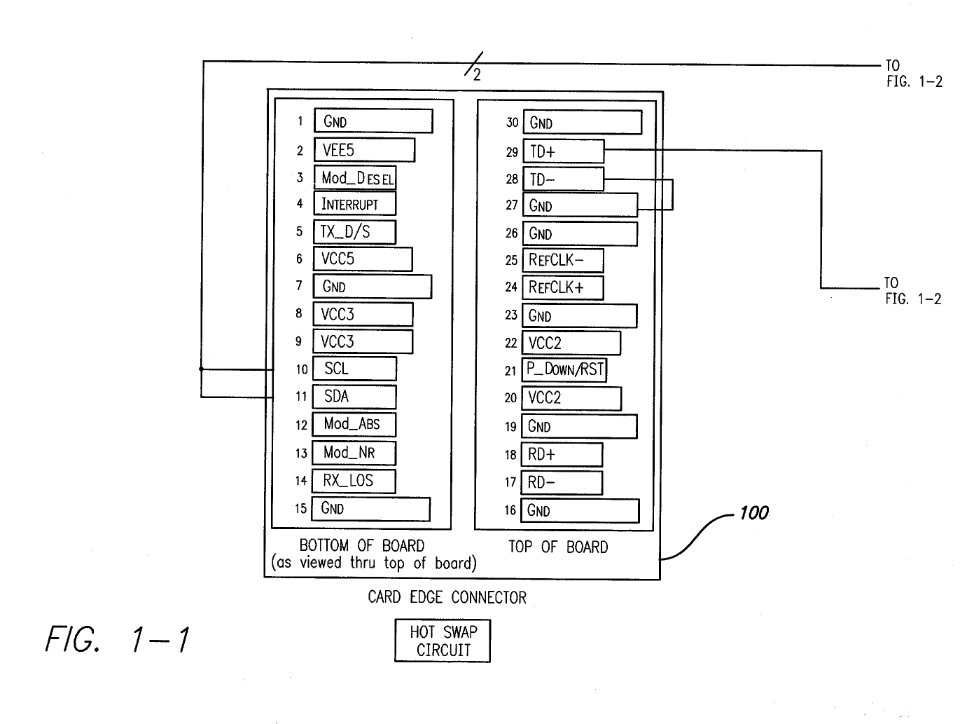

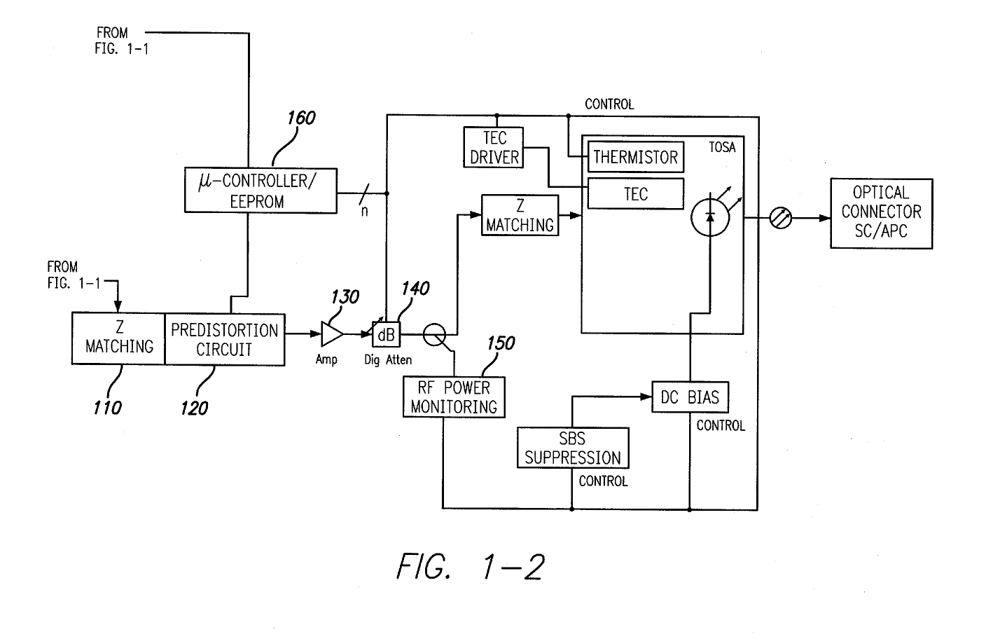

Referring to FIG. 1, a block diagram of an example of an analog transmitter module is shown. This analog transmitter module is capable of receiving the RF signal and transmitting the modulated optical signal over a fiber optic medium. FIG. 1 shows one embodiment of the invention. There are many ways this can be implemented and embodiments of the invention is not limited to only this one illustrated example.

Still referring to FIG. 1, the PCB card-edge connection 100 can accept the DC power, micro controller interface, and the RF input. The RF input may be fed into an impedance matching circuit 110 (Z Matching) then potentially (optionally) to a pre-distortion circuit 120 if needed and then possibly (optionally) to amplifier stages 130 and/or attenuator stages 140. To save board space, the pre-distortion circuit can be split up so that part of it is on the pluggable optical module and the other part is on the host module. An RF power monitoring circuit 150 can monitor the power fed into the optical laser and could feed this information to an on-board microcontroller 160. The on-board microcontroller can monitor and control various parts of the circuitry to optimize performance such as pre-distortion parameters, OMI (optical modulation index), SBS (stimulated Brillouin scattering), suppression power, etcetera. The optical laser can be any wavelength and power available, for example in the standard 1310 nm or 1550 nm range typical of cable fiber optic networks.

Embodiments of the invention can include a host module. A host module can hold a plurality of pluggable optical modules. These pluggable optical modules can be as described above and illustrated in FIG. 1. The host module may contain a microcontroller to monitor and control the individual pluggable optical modules. The host module may also contain RF signal conditioning as well as DC-DC or AC-DC power supplies to power the pluggable optic modules.

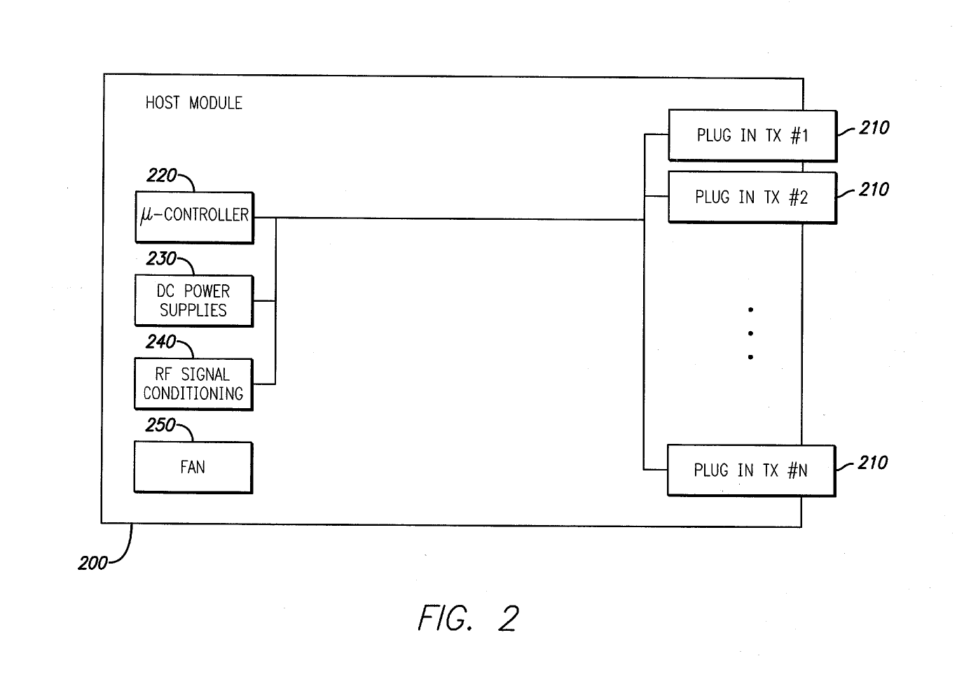

Referring to FIG. 2, one embodiment of a host module 200 is shown. There are many ways the host module can be implemented and embodiments of the invention are not limited to only this one illustrated example. The host can provide slots and/or bays that can accept the pluggable optical modules 210. The slots and/or bays can provide thermal heat sinking, RF shielding and electrical connection between the host and the pluggable optical modules. Optionally, the pluggable optical modules can be hot swapped in and out without affecting the transmission of the other modules.

Still referring to FIG. 2, embodiments of the invention can include a host module with a microcontroller 220 that can provide monitoring and control of the individual modules and potentially provide another interface to an external computer with specialized software to access the hardware. Embodiments of the invention can also include a host module with one or more DC power supplies 230. Embodiments of the invention can also include a host module with an RF signal conditioning circuit 240. This can be any combination of, but not limited to, equalization, signal amplification, attenuation, pre-distortion, and/or impedance matching. One or more fans 250 may be located in association with the host module to provide thermal control of the system.

### Definitions

The terms program and/or software and/or the phrases computer program and/or computer software are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system). The phrase radio frequency (RF) is intended to mean frequencies less than or equal to approximately 300 GHz as well as the infrared spectrum.

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be combined in the disclosed configurations, but could be combined in any and all configurations.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
hosting a plurality of transmitter modules with a host module
wherein the host module includes common circuitry shared by the plurality of pluggable transmitter modules.

2. An apparatus, comprising:
a host module; and
a plurality of transmitter modules coupled to the host module,
wherein the host module includes common circuitry shared by the plurality of pluggable transmitter modules.

3. The apparatus of claim 2, wherein the plurality of transmitter modules includes a plurality of reversibly pluggable analog optical transmitter modules that receive a broadband RF input and transmit a modulated optical signal over a fiber optic medium.

4. The apparatus of claim 3, wherein the plurality of reversibly pluggable analog optical transmitter modules accept at least one member selected from the group consisting of a mixture of analog (8 VSB modulated) channels in addition to QAM channels intended to transmit linear video, SDV (switched digital video), VOD (video on demand), IPTV (internet protocol television) or DOCSIS (data over cable service interface specification) content.

5. The apparatus of claim 3, wherein the plurality of reversibly pluggable analog optical transmitter modules include a card-edge connector that support at least one function selected from the group consisting of DC power, control, broadband RF input, signal conditioning, impedance matching, thermal electric cooler control, stimulated Brillouin scattering suppression or hot swapping.

6. The apparatus of claim 2, wherein the plurality of pluggable transmitter modules include at least one member selected from the group consisting of an impedance matching circuit, a pre-distortion circuit, amplifier stages, attenuator stages, an RF power monitoring circuit or an on-board microcontroller.

7. The apparatus of claim 2, wherein the host module includes at least one member selected from the group consisting of an RF signal conditioning circuit, DC-DC power supply or AC-DC power supply.

8. The apparatus of claim 2, wherein the plurality of optical transmitter modules are coupled to the host module with bays that provide thermal heat sinking, RF shielding and electrical connection between the host and the pluggable optical modules.

9. The apparatus of claim 3, wherein each of the plurality of reversibly pluggable analog optical transmitter modules can be hot swapped in and out without affecting the transmission of the other modules.

10. The apparatus of claim 2, wherein the host module includes an RF signal conditioning circuit including at least one member selected from the group consisting of equalization, signal amplification, attenuation, pre-distortion or impedance matching.
